(19) United States
(12) Patent Application Publication
(10) Pub. No.: US 2009/0243383 A1
(43) Pub. Date: Oct. 1, 2009

(54) CONVERSION KIT FOR A TRACKED VEHICLE TO RIDE ON TIRES

(76) Inventor: Carlyn J. Stubbs, Colorado City, AZ (US)

Correspondence Address: BATEMAN IP LAW GROUP, P.O. BOX 1319, SALT LAKE CITY, UT, 84110, US

(21) Appl. No.: 12/395,446

(22) Filed: Feb. 27, 2009

Related U.S. Application Data
(60) Provisional application No. 61/032,567, filed on Feb. 29, 2008.

(51) Int. Cl. B62D 55/04; B23P 11/00

(52) U.S. Cl. 305/15; 29/428

(57) ABSTRACT

The conversion kit changes a conventional tracked excavator into a rubber tired excavator in just a matter of minutes. Thus, a tracked excavator can be driven down the road on pavement without the need for a transport truck and without damaging the pavement.

### PRIORITY

This application claims priority to U.S. Provisional Patent Application No. 61/032567, filed Feb. 29, 2008, which is incorporated herein by reference in its entirety.

### FIELD

This application relates generally to modification of tracked vehicles. In particular, this application relates to converting tracked equipment to ride on tires.

### BACKGROUND

Tracked vehicles such as excavators, sometimes referred to as track-hoes, are widely used in excavation and construction. Excavators are generally tracked vehicles to provide stability and traction in a variety of working environments. For example, an excavator generally does not require outriggers required by wheeled vehicles, such as back-hoes. The wide and long track also provides greater and firmer contact with the ground than the tires of a back-hoe. In muddy or loose-soil conditions the large contact surface area of a track allows a tracked vehicle to operate in conditions where wheeled vehicles would be stuck.

Tracked vehicles such as excavators have a track on each side of the vehicle. Tracked vehicles are driven by turning a drive gear attached to each of the tracks. Each track is supported by other passive gears and pulleys that rotate when the track rotates. The drive gear is driven by the engine through a transmission and causes the track to move when engaged. The drive gears on each side of the tracked vehicle are independently controlled. Tracked vehicles are turned by engaging one track and not the other, or by engaging one track in one direction and the other in the opposite direction, which results in a zero-radius turn.

When tracked vehicles turn portions of the tracks slide across the ground, and may cause damage to the surface of the ground due to the weight of the vehicle and the sliding. For example, tracked vehicles may destroy or seriously damage paved surfaces when turning. Consequently, tracked vehicles are generally not driven on paved surfaces to avoid damage to those surfaces. This restriction on paved-surface travel can increase costs and time for certain jobs. For example, an excavator may be used to dig foundations and/or basements for a number of building sites in a development. When moving from one building site to another in the same development, it is often necessary to load and secure the excavator on a flatbed trailer for transport to a lot on the other side of the road or within a few hundred yards of the first site. Loading the excavator can take a significant amount of time and requires that the truck be available to transport the excavator frequently, rather than being available to move other loads and equipment.

### SUMMARY

This kit is a bolt on kit that may be specifically built for each make of excavator. The kit includes front wheels that may be steerable by attaching them to a push blade, which may be included with the excavator, depending on the make and model. For example, the Kobelco® ED150 includes a six-way hydraulically controlled blade. When wheels with tires are attached to ends of the blade, the controls used to control the blade may be used to steer the excavator when riding on the tires.

The kit also includes rear wheels that may be attached to one of the sprockets or pulleys in the track drive train of the excavator. For example, the rear wheels may be attached to the rear-most track gear. A wheel adapter may be bolted to the track gear that extends out away from the outside edge of the track to allow the rear wheels to be larger than the track and suspend the excavator above the ground. A hub may be attached to the adapter to provide lugs for the rear wheels. When the tracks of the excavator are engaged, the rear wheels are turned because they are attached to the drive train of the excavator. For example, in many excavators, the two foot pedals that drive the tracks will now drive the two rubber tires mounted to the final drive. The control that operates the angle on the blade now operates the steering on the two front tires.

These and other aspects of the embodiments of a tracked to wheeled vehicle conversion kit are shown and described in the following figures and related description.

### BRIEF DESCRIPTION OF THE DRAWINGS

Various embodiments of the present invention are shown and described in reference to the numbered drawings wherein:

FIG. 1 illustrates a perspective view of an excavator with an embodiment of a conversion kit attached and an exploded view of the rear wheel assembly;

FIG. 2 illustrates an exploded view of a front wheel assembly attached to a push blade of an excavator; and

FIG. 3 illustrates a perspective view of an excavator with an embodiment of a conversion kit attached.

It will be appreciated that the drawings are illustrative and not limiting of the scope of embodiments of the invention, which is defined by the appended claims. The embodiments shown accomplish various aspects and objects of the invention, and are exemplary and do not and are not intended to limit the overall scope of the invention and its equivalents. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

The figures illustrate track to wheeled vehicle conversion kit 10. The excavator 15 illustrated is exemplary only, as embodiments of kit 10 along with aspects and features of kit 10, may be used with various different tracked vehicles, such as bull-dozers, skid steers, etc. For the purpose of illustration and description, the figures and following description focus on the exemplary embodiments of a wheel conversion kit 10 for excavator 15.

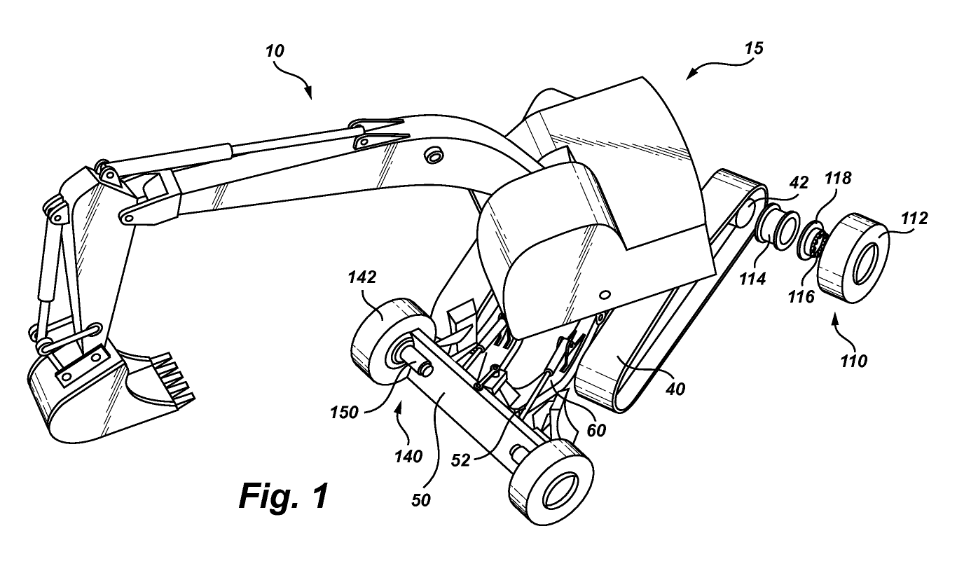

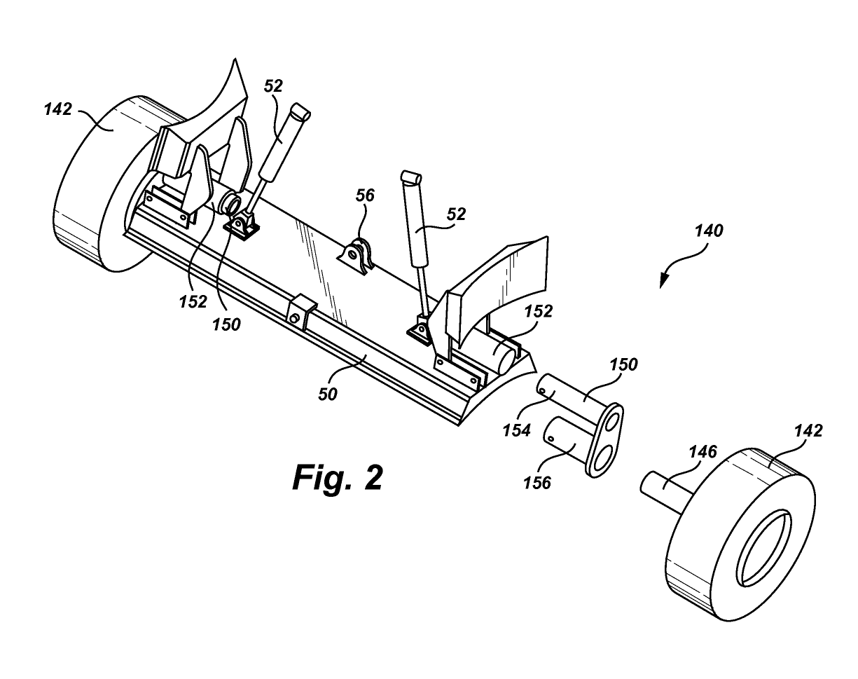

As illustrated in FIGS. 1 and 2, conversion kit 10 may be attached to tracked excavator 15, to convert the tracked vehicle into a wheeled vehicle that may be driven on paved surfaces with minimal damage to the paved surface. Conversion kit 10 may include steering wheels or front wheel assembly 140 and drive wheels or rear wheel assembly 110.

Rear wheel assembly 110 includes components to attach wheels with rubber tires 112 to track gear 42 of track 40. Rear wheel assembly 110 may include wheel adaptor 114 and hub 118. Wheel adaptor 114 may be attached to track gear 42. Wheel adaptor 114 may be temporarily attached, such as by bolts, or permanently attached, such as by welding, to track gear 42. In some embodiments, wheel adaptor 114 may be integrally formed with track gear 42 as a replacement track gear. Wheel adaptor 114 may be constructed to provide an extended connection for wheel 112 outside of the outer edge of track 40.

In some embodiments, rear wheel assembly 110 may include hub 118 with lugs 116 for attaching to wheel 112. Hub 118 may be bolted to wheel adaptor 114. Hub 118 may be selected to provide a bolt pattern for a desired wheel size and make. In some embodiments, hub 118 may be integrally formed with wheel adaptor 114, or may be welded to wheel adaptor 114. Thus, in the illustrated embodiment, wheel adaptor 114 is coupled to track gear 42 and to wheel 112 through hub 116. When track 40 is turned using the controls and engine of excavator 15, wheel adaptor 114 is also turned, providing power to wheel 112 to move excavator 15.

As shown in FIGS. 1 and 2, front wheel assembly 140 may be attached to push blade 50 of excavator 15. Front wheel assembly 140 may include adaptor 150, wheel 142, and axle 146. Push blade 50 may original equipment or previously installed optional equipment for excavator 15. Push blade 50 may be attached to excavator 15 through attachment 60, and may be controlled and moved with hydraulic cylinders 52.

In some embodiments, conversion kit 10 may include blade 50 and attachment 60 to couple blade 50 through attachment point 56 to excavator 15. Attachment 60 may be coupled to the frame of excavator 15. Hydraulic cylinders 52 may be provided at coupled to the hydraulic system of excavator 15. Many excavators have supplemental controls, such as a thumb control on the vehicle controls, for driving auxiliary attachments on the excavator, and connection points in the hydraulic system for attaching the auxiliary attachments. These supplemental controls and auxiliary attachments may be used to control the steering of front wheel assembly 140.

Blade 50 may include mounting points 152 positioned on blade to provide connection for adaptor 150. Mounting points 152 may be a sleeve, as illustrated, or may be a plate, or other design to allow adaptor 150 to be coupled to blade 50. Similarly, mounting point 152 may be square, similar to a standard trailer hitch receiver, or may include an angle with bolt holes to attach adaptor 150 to blade 50.

Adaptor 150 may include axle sleeve 156 and attachment sleeve 154. Attachment sleeve 156 may be placed in mounting points 152 and then secured to blade 50 with a pin (not shown) or other attachment devices. Adaptor 150 may provide additional forward positioning of wheels 142 to allow for a greater maneuverability of excavator 15 by extending the possible movement of blade 50 before wheels 142 contacts track 40 when turning. Axle 146 may be secured to axle sleeve 156 in a similar manner to that of attachment sleeve 156 and mounting points 152 with pins or other attachment devices, such as bolts or by welding. In some embodiments, adaptor 150 may not be necessary, or may be excluded, as axle 146 may be coupled to mounting points 152. Axle 146 may be attached to wheel 142 using a hub and lugs.

In some embodiments, kit 10 may be attached to excavator 15 by attaching wheel adaptor 114 to track gear 42 and hub 118 to wheel adaptor 114. Adaptor 114 may be attached by removing the OEM bolts, placing the adaptor 114 directly over the final drive track gear 42, and installing new bolts long enough to secure both adaptor 114 and the track gear 42 to excavator 15. The bucket of excavator 15 may be used to raise one end of tracks 40, such as a rear end near track gear 42. Once the wheel adaptor is sufficiently raised, drive wheel 112 may be attached to hub 118 with lugs 116 for both tracks 40 and tightened. When the tracks 40 are lowered, drive wheels 112 will then contact the ground and maintain a portion of tracks 40 suspended above the ground, such that drive wheels 112 will support a portion of excavator 15.

The front end of excavator 15, near blade 50, may then be raised with the bucket, or blade 50 may be sufficiently raised using hydraulic controls, and wheels 142 may be attached to adaptor 150 on blade 50. When excavator 15 is then lowered, the entire weight of excavator 15 will be borne by wheels 112 and 142. Excavator 15 may then be driven on the wheels. To drive excavator 15 on the wheels, the tracks 40 are driven as normal, thereby driving drive wheels 112 to propel excavator 15. Excavator 15 may be steered by manipulating cylinders 52 side-to-side, to change direction of front wheel assembly 140. In the event excavator 15 becomes stuck in the mud or the snow, blade 50 may be raised to allow a portion of tracks 40 to contact the ground for additional traction.

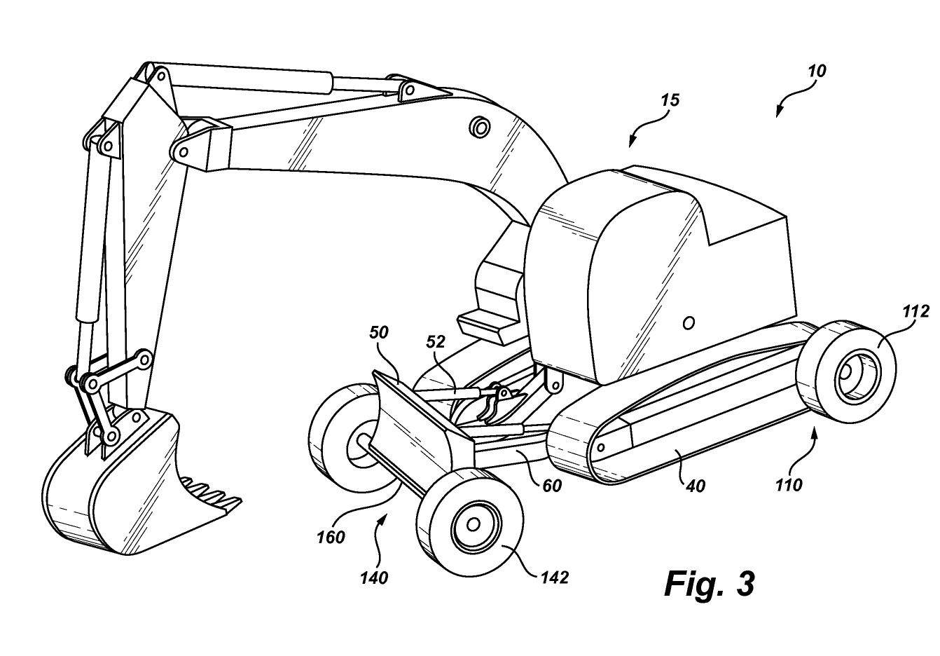

FIG. 3 illustrates an embodiment of excavator 15 with another embodiment of front wheel assembly 140. In FIG. 3, a solid axle 160 extends between wheels 142. Axle 160 may be coupled to blade 50 with mounting points similar to mounting points 152 described above. Axle 160 and wheels 142 may be a single, dolly-like assembly that may easily be attached to blade 50 by slipping over a portion of the blade, or with additional attachment devices, such as chains to coupled front wheel assembly 140 to blade 50.

In some embodiments, a rear tag axle may be included on excavator 15, as a replacement for rear wheel assembly 110. Similarly, a hydraulic dropping axle may also replace front wheel assembly 140. Wheels 112 and wheels 142 may have tires, which can be manufactured of any material suitable for the purpose and able to carry the weight such as but not limited to solid rubber, plastic, or air filled rubber, or other tire types and designs.

With kit 10 installed and with excavator riding on wheels 112, 142, excavator 15 can also be used on paved roads for applications such as craning concrete barriers etc. also for snow removal within added snow plow or snow blower. The machine is simply driven by using the drive pedals that normally drive the tracks. It is steered down the road by pushing the control that angles the dozer blade. As will be appreciate by those of ordinary skill, there are many ways that kit 10 and excavator 15 could be built differently.

In some embodiments, snow chains may be installed on the rubber tires; then a snow play or a snow blower can be used to remove snow on paved roads. The track excavator 15 may be driven on the road like a loader or a regular rubber tired excavator and still have all the advantages of a track excavator once at a jobsite. Tracks 40 may be taken completely off if rubber tires are needed for an extended period of time, or to repair the tracks. Otherwise tracks 40 just turn in the air as excavator 15 is driven down the road on rubber tires of wheels 112, 142.

It will be appreciated that numerous changes may be made to the present invention without departing from the scope of the claims.

What is claimed is:

1. A kit for a tracked vehicle, comprising:
a first wheel adaptor configured to be coupled to a first track drive component;
a first wheel having a rubber tire coupled to the first wheel adaptor; and
an axle assembly configured to couple at least one tire to a controllably positionable portion attached to the tracked vehicle.

2. The kit of claim 1, further comprising a second wheel adaptor configured to be coupled to a second track drive component.

3. The kit of claim 1, wherein the at least one tire is a first tire and a second tire and wherein the axle assembly includes a first connector body coupled to the portion and coupled to the first tire, and wherein the axle assembly includes a second connector body coupled to the blade and to the second tire.

4. The kit of claim 1, wherein the first track drive component is a sprocket configured to engage the track of the tracked vehicle.

5. The kit of claim 1, further comprising a hub configured to be attached to the first wheel adaptor and to the first wheel.

6. The kit of claim 1, wherein the first wheel adaptor and the axle assembly are configured to be attached to the tracked vehicle with bolts.

7. The kit of claim 1, wherein the controllably positionable portion is controlled using hydraulics.

8. The kit of claim 7, wherein the controllably positionable portion is an earth-moving blade.

9. The kit of claim 7, wherein the controllably movable portion is bolted to a frame of the tracked vehicle.

10. The kit of claim 1, wherein the tracked vehicle is an excavator with a blade attachment, and wherein the blade attachment is the controllably positionable portion.

11. A kit for a tracked vehicle, comprising:
a first and second drive wheel assemblies, wherein each of the drive wheel assemblies includes,
a wheel adaptor configured to be bolted to a drive train component of the tracked vehicle,
a drive wheel configured to be coupled to the wheel adaptor, and
a rubber tire on the drive wheel; and
a front wheel assembly, including,
at least one axle configured to be coupled to the tracked vehicle, and
at least one wheel and rubber tire rotatably attached to the at least one axle.

12. The kit of claim 11, wherein the drive train component is the rearmost track gear of the tracked vehicle.

13. The kit of claim 12, wherein the wheel adaptor is configured to hold the drive wheel extended beyond the outer width of the track of the tracked vehicle.

14. The kit of claim 11, wherein the rubber tire on the drive wheel has an outer diameter sufficient such that when the wheel adaptor is bolted to the drive train component, the track adjacent to the rubber tire on the drive wheel is suspended off of the ground.

15. The kit of claim 11, wherein when kit is attached to the tracked vehicle, the tracked vehicle is suspended by the first and second drive wheel assemblies and the front wheel assembly.

16. The kit of claim 15, wherein when the kit is attached to the tracked vehicle, engaging the tracks of the tracked vehicle to drive causes the drive wheels of the first and second drive wheel assemblies to rotate.

17. The kit of claim 11, further comprising a steering member, wherein the steering member is coupled to the front wheel assembly, a frame of the tracked vehicle, and a hydraulic system of the tracked vehicle.

18. The kit of claim 17, wherein the steering member is a hydraulically controlled earth-moving blade coupled to the tracked vehicle.

19. The kit of claim 17, wherein the steering member is configured to be controlled from the cab of the tracked vehicle.

20. A method of attaching tires to a tracked vehicle, comprising:
attaching a wheel adaptor to a track gear on each track of the tracked vehicle;
lifting a first end of the tracked vehicle to suspend a portion of the track;
attaching a drive tire to each wheel adaptor;
lowering the lifted end of the tracked vehicle until each tire is in contact with the ground;
lifting second end of the tracked vehicle;
attaching a steering tire to a controllable blade of the tracked vehicle; and
lowering the second end of the tracked vehicle until the tracked vehicle is suspended by the drive tires and the steering tires.

21. The method of claim 19, wherein the controllable blade is a hydraulically controlled earth-moving blade.

22. The method of claim 19, wherein the tracked vehicle is an excavator.
